(19) United States
(12) Patent Application Publication
(10) Pub. No.: US 2014/0118505 A1
(43) Pub. Date: May 1, 2014

(54) Stereoscopic image capture

(71) Applicant: REALD INC., Beverly Hills, CA (US)

(72) Inventors: Miller H. Schuck, Erie, CO (US); David A. Coleman, Louisville, CO (US); Douglas J. McKnight, Boulder, CO (US)

(73) Assignee: REALD INC., Beverly Hills, CA (US)

(21) Appl. No.: 14/064,765

(22) Filed: Oct. 28, 2013

Related U.S. Application Data
(60) Provisional application No. 61/718,967, filed on Oct. 26, 2012.

(51) Int. Cl. G03B 35/04; H04N 13/02

(52) U.S. Cl. CPC G03B 35/04; H04N 13/0207
USPC 348/49

(57) ABSTRACT

The present application provides a single lens capture device having a single input port. The single lens capture device may include an objective lens, a fixed objective lens aperture, off-center apertures inside the objective lens, and a sensor. The sensor is operable to capture images at a rate of at least two times the rate of stereoscopic presentation.

### CROSS-REFERENCE TO RELATED APPLICATION

This application relates and claims priority to commonly-assigned U.S. Provisional Patent Application No. 61/718,967, filed Oct. 26, 2012, and entitled “Stereoscopic camera” which is herein incorporated by reference in its entirety for all purposes.

### TECHNICAL FIELD

The present disclosure generally relates to display technology and image capture, and more specifically, to two dimensional and three dimensional display technologies and image capture.

### BACKGROUND

Generally, current stereoscopic technologies may include functionality to capture, deploy, view and/or display three dimensional (“3D”) content. 3-D or stereoscopic image presentation is enabled by presenting independent left and right eye views to a person. The independent left and right eye views have slight disparities in image location and scene which create the illusion of a three-dimensional volume.

### SUMMARY

An embodiment of a capture apparatus include an objective lens operable to receive light along an input light path, a fixed objective lens aperture defined in the input light path and having an objective lens optical axis, at least two offsetting apertures operable to receive light transmitted through the fixed objective lens aperture, the at least two offsetting apertures having transmitting areas offset from the objective lens optical axis by a displacement distance, and a sensor operable to receive light transmitted by the at least two offsetting apertures.

An embodiment of a method of capturing imagery may include providing a capture device comprising an objective lens operable to receive light along an input light path, a fixed objective lens aperture defined in the input light path and having an objective lens optical axis, at least two offsetting apertures operable to receive light transmitted through the fixed objective lens aperture, the at least two offsetting apertures having transmitting areas offset from the objective lens optical axis by a displacement distance, and a sensor operable to receive light transmitted by the at least two offsetting apertures. The method may further include transmitting a first stereoscopic view through a first of the at least two offsetting apertures during a first portion of a first frame and transmitting a second stereoscopic view through a second of the at least two offsetting apertures during a second portion of the first frame. The first and second portion of the first frame substantially do not overlap and each have a centroid of image energy near the middle of the first frame in time.

Another embodiment of a capture apparatus include an objective lens operable to receive light along an input light path, a fixed objective lens aperture defined in the input light path and having an objective lens optical axis, at least two offsetting apertures operable to receive light transmitted through the fixed objective lens aperture, the at least two offsetting apertures having transmitting areas offset from the objective lens optical axis by a displacement distance, a sensor operable to receive light transmitted by the at least two offsetting apertures, and a relay lens between the at least two offsetting apertures and the sensor.

### BRIEF DESCRIPTION OF THE DRAWINGS

Embodiments are illustrated by way of example in the accompanying figures, in which like reference numbers indicate similar parts, and in which:

FIG. 1 is a schematic diagram illustrating a top view of a side-by-side rig including cameras;

FIG. 2A is a schematic diagram illustrating a side view of a beam splitter rig including cameras;

FIG. 2B is a schematic diagram illustrating a perspective back view of a beam splitter rig of FIG. 2A;

FIG. 3a is a schematic diagram illustrating a side view of an exemplary single lens capture device, in accordance with the present disclosure;

FIG. 3b is a schematic diagram illustrating the apertures relating to the objective lens of FIG. 3a, in accordance with the present disclosure, in accordance with the present disclosure;

FIG. 4a is a schematic timing diagram showing exemplary sequential timing for light capture through the left- and right-eye apertures, in accordance with the present disclosure;

FIG. 4b is a schematic timing diagram showing another exemplary sequential timing for light capture through the left- and right-eye apertures, in accordance with the present disclosure;

FIG. 4c is a schematic timing diagram showing yet another exemplary sequential timing for light capture through the left- and right-eye apertures, in accordance with the present disclosure;

FIG. 5a is a schematic diagram illustrating the apertures in operation in accordance with the exemplary sequential timing of FIG. 4b;

FIG. 5b is a schematic diagram illustrating the apertures in operation in accordance with the exemplary sequential timing of FIG. 4c;

FIG. 6 is a schematic diagram illustrating a side view of an apparatus for image capture and ray traces therethrough, in accordance with the present disclosure;

FIG. 7 is a schematic diagram illustrating a side view of an apparatus with zoom relay lens for image capture and ray traces therethrough, in accordance with the present disclosure;

FIG. 8a is a schematic diagram of a side view of an apparatus for capture and ray traces therethrough in capturing a left-eye scene, in accordance with the present disclosure;

FIG. 8b is a schematic diagram of a side view of an apparatus for capture and ray traces therethrough in capturing a right-eye scene, in accordance with the present disclosure;

FIG. 9 is a schematic diagram of a side view of an apparatus for capture and ray traces therethrough, in accordance with the present disclosure; and

FIG. 10 is a schematic diagram of a side view of an apparatus for capture and ray traces therethrough, in accordance with the present disclosure.

### DETAILED DESCRIPTION

To capture live scenes for stereoscopic imaging, two cameras may be used for the independent views. The cameras are physically offset from one another with this separation termed interaxial separation or IA, and rotation in the horizontal plane, termed vergence or convergence, controlling the depth and location of the scene volume (respectively) as the imagery is displayed to the viewer.

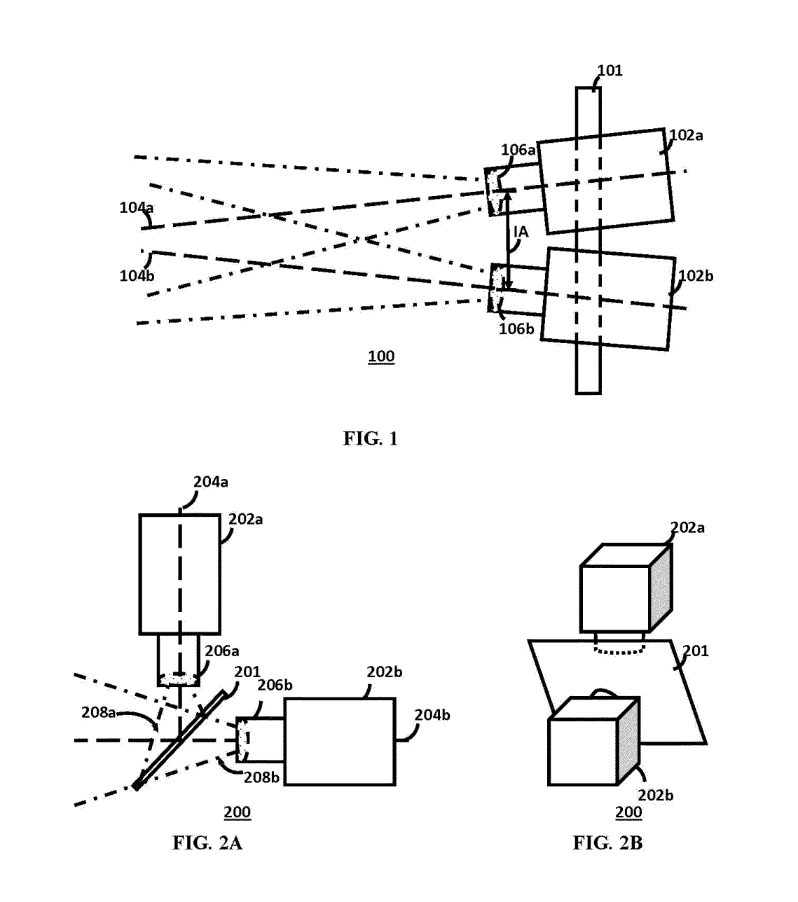

Generally, two broad categories of stereoscopic camera systems or rigs include side-by-side rigs or beam splitter rigs. FIG. 1 is a schematic diagram illustrating a top view of a side-by-side rig 100. The side-by-side rig 100 as illustrated in FIG. 1 may include two cameras 102a and 102b having respective optical axes 104a and 104b defined through respective camera lenses 106a and 106b. The cameras 102a and 102b may be affixed to a mechanical rail 101 with optical axes 104a and 104b pointing generally in the same direction.

As previously discussed, the cameras 102a and 102b are physically offset from one another, with the separation referred to herein as an interaxial separation, or “IA.” The IA may be the distance between the centers of the camera lenses 106a and 106b; stated differently the IA may be generally determined by the separation of the optical axes 104a and 104b of the camera lenses 106a and 106b. The rotation in the horizontal plane, or convergence, may be determined by the angle of the camera lenses 106a and 106b with respect to one another in the horizontal plane. It is to be appreciated that the horizontal plane is the plane of the page, and rotation in the horizontal plane referred to herein may be a rotation about an axis that is normal to the page. The minimum IA for side-by-side rigs may be determined and limited by the physical size of the camera and/or lens. For close-up scenes, the minimum IA in the rig 100 may produce too large a disparity in the stereoscopic imagery for comfortable viewing.

FIG. 2A is a schematic diagram illustrating a side view of a beam splitter rig 200, and FIG. 2B is a schematic diagram illustrating a back view of the beam splitter rig 200. The beam splitter rig 200 may include two cameras 202a and 202b. Cameras 202a and 202b may have respective optical axes 204a and 204b defined by respective camera lenses 206a and 206b. The cameras 202a and 202b may be affixed to a mechanical support (not shown) such that the optical axes 204a and 204b point in approximately orthogonal directions to one another. A beam splitting element 201 may be placed in the overlapping frustums formed by the fields of view 208a and 208b of the two cameras 202a and 202b. The beam splitting element 201 may be any suitable beam splitter known in the art, including but not limited to a cube, a prism, or a mirror such as a half-silvered plate mirror. One of the cameras 202a and 202b may capture an image reflected by the beam splitting element 201, while the other may capture an image transmitted by the beam splitting element 201.

The IA of the beam splitter rig 200 may be adjusted by sliding the cameras 202a and 202b along rails (not shown) substantially perpendicular to the optical axes 204a and 204b. The convergence of the beam splitter rig 200 may be determined by the angular rotation of the lenses 206a and 206b in their respective horizontal planes. Unlike the rig 100, the beam splitter rig 200 does not have a minimum IA, as the two cameras 202a and 202b do not physically occupy the same space. In an embodiment, the beam splitter rig 200 may however have a maximum IA, which may be determined by the size of the beam splitting element 201 and/or the mechanical support rails (not shown).

When capturing two images, filmmakers may employ various shooting methods such as parallel or converged shooting methods. Parallel shooting may include locating both cameras such that the optical axes of the cameras are approximately parallel when viewing the scene. In one embodiment, the beam splitter rig 200 may be used for parallel shooting, and the optical axes 204a and 204b of the cameras 202a and 202b, respectively, may be approximately perpendicular in physical space, and optically parallel as one optical axis is reflected by the beam splitting element 201. When parallel shooting is used on the set, the amount of IA determines scene volume. Convergence or locating the scene volume relative to the viewing screen may then be determined by horizontally translating the images, an operation termed HIT, in post-production.

Converged shooting may be enabled by adjusting the IA and/or convergence of the capture cameras. Converged shooting may provide more subtle viewing around objects in a scene which may result in a better sense of “roundness” in the stereoscopic image. Converging the cameras may induce keystone distortion, of opposite sense, in the captured left and right eye imagery, and the keystone distortion may be addressed with geometric correction or image warping in post-production. Parallel shooting theoretically requires little to no correction of keystone distortion in the two images. Converged shooting can also utilize HIT in post-production to fine tune the convergence.

Both the side-by-side rig 100 and the beam splitter rig 200 can be bulky and heavy, limiting their use in mobile or confined shooting scenarios. Additionally, both rigs 100 and 200 can be very expensive to purchase, prohibiting lower budget films from utilizing stereoscopic imagery. Both rigs suffer from mismatched lens magnification, zoom, iris, focus and centration errors, often involving sorting for matched lenses or complicated control loops for actuating the camera alignment. At times, actuating the cameras may not resolve all of the mismatch issues. Rigs 100 and 200 require calibration to reduce alignment errors prior to shooting, slowing down the production process.

In some embodiments, the beam splitter rig 200 may produce both local and global color and luminance mismatches between the two camera views, which may lead to post-production correction of the two images. Optical wavefront errors in the beam splitting element 201 can induce asymmetric distortions in the two images. These errors may result in time consuming fixes in post-production, becoming costly and slowing down the workflow and degrading the final stereoscopic image quality.

It is to be noted that a large portion of stereoscopic cinema shooting may be achieved with a wide angle zoom lens and IAs less than approximately 25 mm. Accordingly, the present disclosure provides embodiments involving single lens systems having a single lens input port with a plurality of apertures because such single lens systems may remove much of the bulk and weight of rigs like the rigs 100 and 200. Additionally, cost can be reduced by reduction of optical and mechanical elements. Lens matching and daily alignment calibration may not be issues as both images pass through a single lens input port. As used herein, the term “single lens input port” does not mean one lens, but refers to a single input port for receiving left- and right-eye images from a scene, as is consistent with the teachings of the present disclosure. In contrast, the dual-camera rigs 100 and 200 shown in FIGS. 1 and 2, respectively, are dual lens system having dual input ports.

One approach, which is set forth and generally discussed in the paper “Polarizing aperture stereoscopic cinema camera” by Lenny Lipton (Proc. SPIE 8288, Stereoscopic Displays and Applications XXIII, 828806, Feb. 9, 2012), which is herein incorporated by reference in its entirety, involves programmable liquid crystal apertures in the lens aperture stop coupled with patterned wire grid polarizers at the sensor plane. This approach, however, may suffer from several issues, including low contrast, reduction of dynamic range and a reduction of image resolution. Additionally, the pupils in this system will not overlap, limiting the minimum achievable IA. Finally, the maximum IA is limited by the size of the entrance pupil of the capture lens which can be small and varies significantly with zoom.

The present application addresses these issues and others by providing a stereoscopic capture device, comprising an objective lens operable to receive input light, a fixed objective lens aperture, sequentially transmitting and off-center apertures, which may be inside the objective lens, and a sensor operable to capture images at high frame rate. The high frame rate sensor is operable to capture images at a rate of at least two times the rate of stereoscopic presentation. A further embodiment may include a relay lens between the objective lens and sensor. The relay lens allows for a change in image magnification from objective lens to sensor plane, effectively decoupling the objective lens entrance pupil size from the sensor size or resolution and system field of view. The relay lens may optionally be a zoom lens, allowing for a change in system field of view at full resolution without a change in objective entrance pupil aperture size. With appropriate apertures, the sensor can be high-contrast.

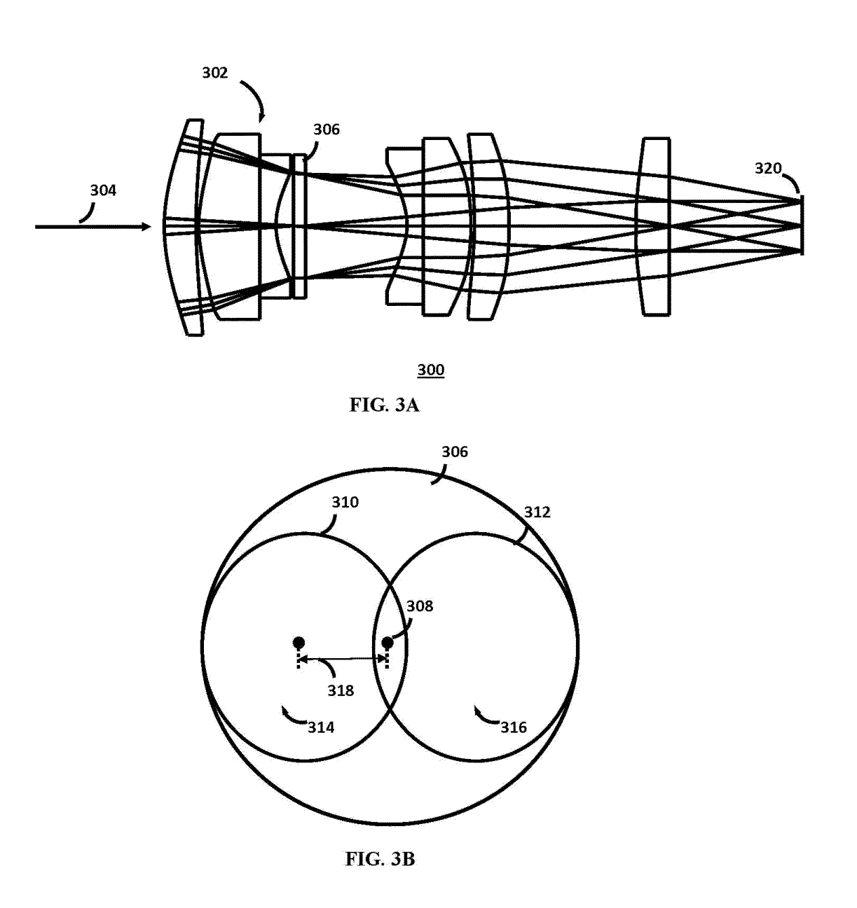

FIG. 3a is a side view of an exemplary embodiment of a capture device 300. The capture device 300 may include an objective lens 302 operable to receive light along an input light path 304. The objective lens 302 may have a fixed focal length or small focal length zoom range. The entrance pupil for a fixed focal length objective lens typically does not vary in size and location. In an embodiment, the objective lens 302 is telecentric in the image plane and has an entrance pupil diameter of at least 10 mm and closer to 35 mm, larger than the 25 mm IA typical of many stereoscopic shots. In an embodiment, that the objective lens 302 may have low f-number for compactness. As an example, FIG. 3a depicts a double-Gauss fixed focal length objective lens with low f-number and telecentric in image space.

The capture device 300 may also include a fixed objective lens aperture 306 defined in the input light path 304.

FIG. 3b is a view of the fixed objective lens aperture 306 along an axis defined by the input light path 304. As shown, the fixed objective lens aperture 306 may have an objective lens optical axis 308, which would be coming out of the page in the illustration in FIG. 3b.

Referring to FIGS. 3a and 3b, the capture device 300 may include at least two offsetting apertures 310 and 312 operable to receive light transmitted through the fixed objective lens aperture 306.

The fixed objective lens aperture 306 determines the minimum f-number. The at least two offsetting apertures 310 and 312 may operate in a sequential manner and comprise, in an embodiment, rapidly switching mechanical apertures located near the fixed objective lens aperture 306. As illustrated, the at least two offsetting apertures 310 and 312 may have transmitting areas 314 and 316 offset from the objective lens optical axis 308 by a displacement distance 318. The transmitting areas 314 and 316 may be centroids. The amount of displacement 318 for each of the at least two offsetting apertures 310 and 312 is variable, from zero displacement (for 2D capture) to the full radius of the fixed aperture (for maximum IA). Each of the at least two offsetting apertures 310 and 312 is operable to be opened in synchrony with the camera capture frame. The at least two offsetting apertures 310 and 312 may be round, elliptical, rectangular, triangular, or some combination of these shapes.

In an embodiment, the at least two offsetting apertures 310 and 312 may comprise high contrast electro-optic devices, such as liquid-crystal shutters (or stacks of liquid crystal shutters). The shutters may be passively or actively matrix-addressed to allow for programming IA's and aperture shapes, sizes and transmissions. The shutters may include any liquid crystal-based polarization switch known in the art, including but not limited to, a push-pull modulator as described in the commonly-owned U.S. Pat. Nos. 4,792,850, and 7,477,206, a pi-cell as described in the commonly-owned U.S. patent application Ser. No. 12/156,683, a ferro-electric LC modulator as described in commonly-owned U.S. Pat. No. 6,078,374, a twisted nematic cell as described in commonly-owned U.S. Pat. No. 6,172,722, or an achromatic polarization switch as described in commonly-owned U.S. Pat. No. 7,528,906, all of which are incorporated by reference herein in their entirety.

The capture device 300 may include a sensor 320 operable to receive light transmitted by the at least two offsetting apertures 310 and 312. The sensor 320 may be a high frame rate camera operable to capture the images from the sequentially opened and displaced apertures 310 and 312. For sequential stereoscopic capture, the different views, such as the left and right views, may be captured at a frequency at least the same as the presentation (or displayed) frequency. Cinema has historically operated at 24 frames per second (fps) for decades, while television operates from 50-60 fps, with frame interpolation increasing television presentation rates to 120 and 240 fps. Recent developments in digital cinema are raising the capture and presentation frame rates to 48 and 60 fps, although these may vary with advances in technology.

It may be advantageous to capture at even higher frame rates, assuming there is sufficient dynamic range in the captured image, and to post-process the imagery for a more pleasing look and a reduction of temporal artifacts.

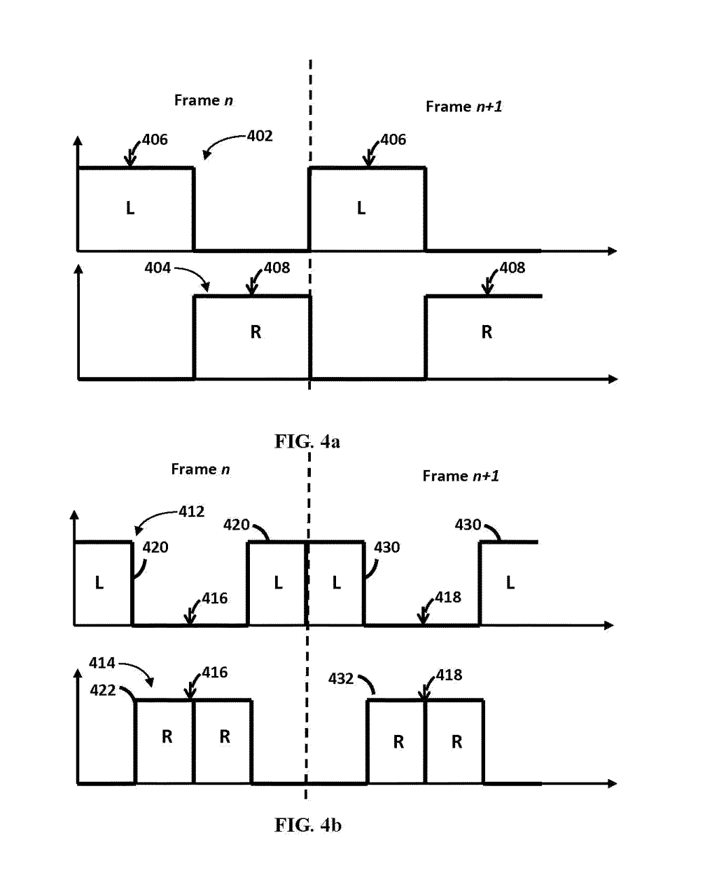

FIG. 4a depicts the transmission versus time diagram of the at least two offsetting apertures. Sequences 402 and 404 depict a standard capture, where the first and second views (e.g., left and right views) are sequentially captured at the same frequency as the intended presentation. Sequences 402 and 404 result in centroids 406 and 408 of image energy in time for the captured information. The resulting images of the first and second views have a time delay between them represented by the difference in energy centroid positions. This can result in inaccurate depth placement for objects moving across the screen.

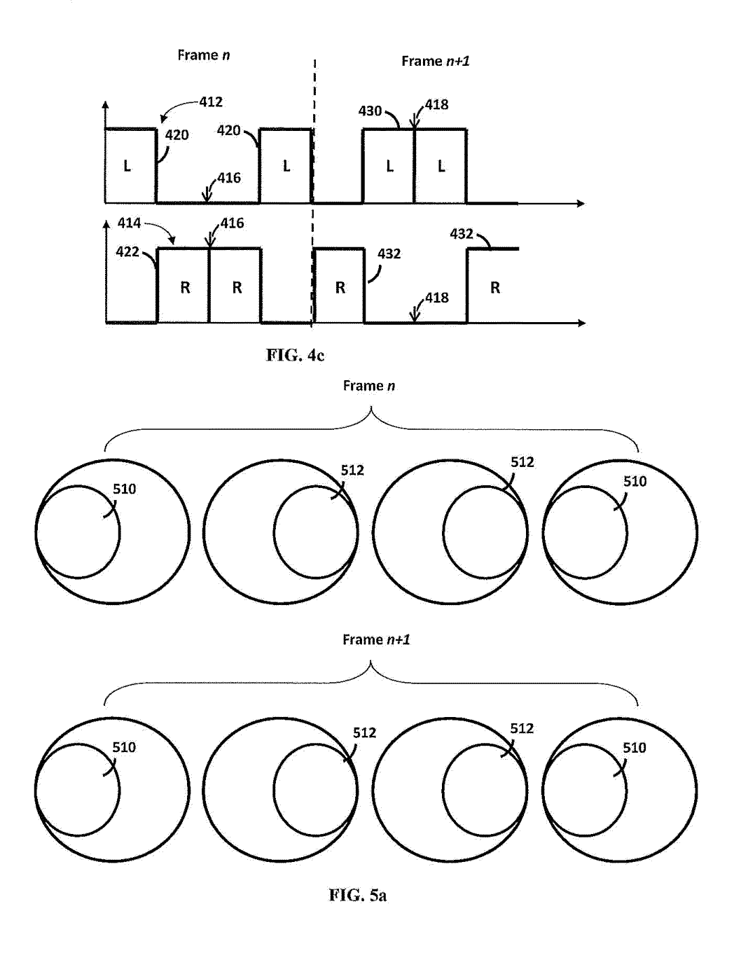

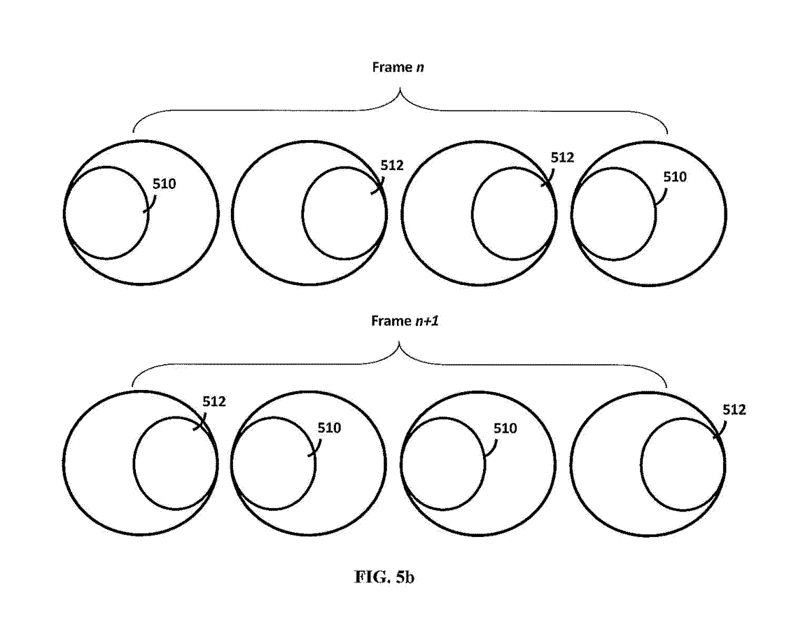

FIGS. 4b and 4c depict the transmission versus time diagrams of the at least two offsetting apertures operating with better matched energy centroid positions. FIGS. 5a and 5b are schematic diagrams illustrating the operation of offsetting apertures 510 and 512 in accordance with the timing diagrams as shown in FIGS. 4b and 4c, respectively. Referring to FIGS. 4b and 5a and FIGS. 4c and 5b, sequences 412 and 414 depict a higher capture rate (twice the rate of sequences 402 and 404). Sequence 412 may include transmitting a first image view through a first of the at least two offsetting apertures 510 and 512 during a first portion 420 of a first frame n, and sequence 414 may include transmitting a second view through a second of the at least two offsetting apertures 510 and 512 during a second portion 422 of the first frame n. The first and second portions 420 and 422 of the first frame n substantially do not overlap and each have a centroid 416 of image energy near the middle of the first frame n in time. In an exemplary embodiment, the first portion 420 of the first frame comprises substantially first and fourth quarters of the first frame n, and the second portion 422 of the first frame comprises substantially second and third quarters of the first frame n. In another embodiment, the first portion 420 of the first frame comprises substantially second and third quarters of the first frame n, and the second portion 422 of the first frame comprises substantially first and fourth quarters of the first frame n.

For a single frame n, the captured portion 420 for the first view (e.g., left view) is averaged, as is the captured portion 422 for the second view (e.g., right view), to produce the final left/right images. The aperture transmission times may have been arranged to produce centroids 416 of image energy with substantially no difference in time between images of the first and second views. The processed left and right eye capture portions 420 and 422 coincide in time allows for an accurate depth placement for objects moving across the screen. It is to be appreciated that higher capture rates would allow finer slicing of the capture frame, and potential for further reducing motion and depth artifacts.

For the next single frame n+1, sequence 412 may further include transmitting the first image view through the first of the at least two offsetting apertures 510 and 512 during a first portion 430 of a second frame n+1, and sequence 414 may include transmitting the second view through the second of the at least two offsetting apertures 510 and 512 during a second portion 432 of the second frame n+1. The first and second portion 430 and 432 of the second frame n+1 substantially do not overlap and each have a centroid 418 of image energy near the middle of the second frame n+1 in time. In an exemplary embodiment as shown in FIG. 4b, the first portion 430 of the second frame n+1 may repeat the pattern of the first portion 420 and comprise substantially first and fourth quarters of the second frame n+1, and the second portion 432 of the second frame n+1 may repeat the pattern of the second portion 422 and comprise substantially second and third quarters of the second frame n+1. In another embodiment as shown in FIG. 4c, the first and second portions 430 and 432 may reverse polarity such that the first portion 430 of the second frame n+1 comprises substantially second and third quarters of the second frame n+1, and the second portion 432 of the second frame n+1 comprises substantially first and fourth quarters of the second frame n+1.

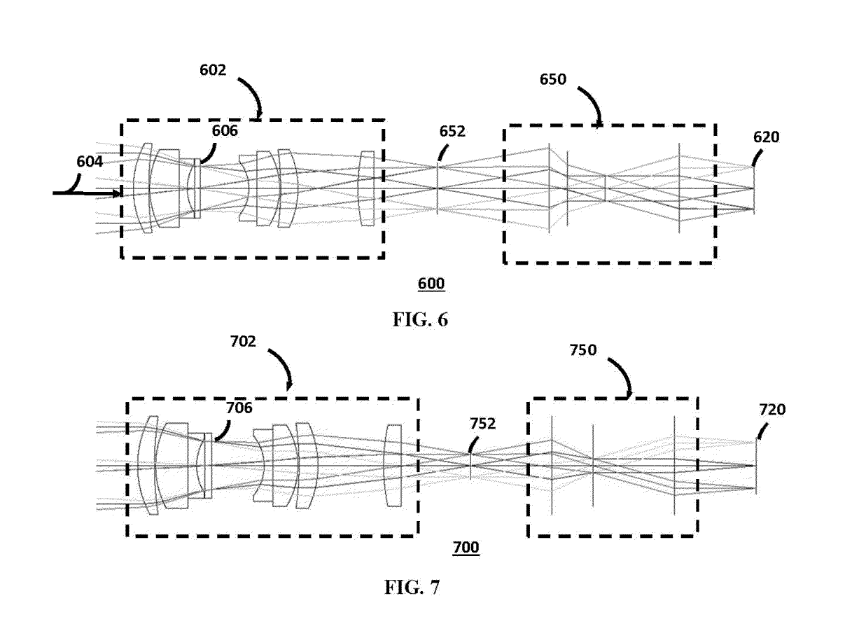

FIG. 6 depicts a capture device 600 that is similar to the capture device 300 but includes a relay lens 650 between the objective lens and camera sensor plane. The capture device 600 may include an objective lens 602 operable to receive light along an input light path 604. The capture device 600 may also include a fixed objective lens aperture 606 defined in the input light path 604. The capture device 600 may include at least two offsetting apertures operable to receive light transmitted through the fixed objective lens aperture 606. The at least two offsetting apertures may have transmitting areas offset from the objective lens optical axis by a displacement distance as discussed with respect to FIGS. 3a and 3b. The capture device 600 may include a sensor 620 operable to receive light transmitted by the at least two offsetting apertures and a relay lens 650 between the objective lens 602 and plane of the sensor 620. The relay lens 650 are operable to form real image at the plane of the sensor 620 of the intermediate image 652 produced by the objective lens. As discussed above, the relay lens 650 of the capture device 600 allows for a change in image magnification from objective lens to sensor plane, effectively decoupling the objective lens entrance pupil size from the sensor size or resolution and system field of view. The relay lens 650 may optionally be a zoom lens, allowing for a change in system field of view at full resolution without a change in objective entrance pupil aperture size.

FIG. 7 depicts a similar capture device 700 comprising a similar objective lens 702 and relay lens 750, however the magnification of the relay lens 750 has been changed via a zoom function. The entrance pupil formed by the aperture 706 is the same size at the entrance pupil formed by aperture 606. The intermediate image 752 is smaller than intermediate image 652, resulting in a smaller field of view (FOV) in the final image. The image at the plane of the sensor 720 however is the same size as the sensor 720, resulting in substantially no loss of resolution in the final image. The zoom relay effectively decouples the entrance pupil size from FOV and resolution, resulting in a full resolution stereoscopic image with a common IA over the zoom range of the relay lens.

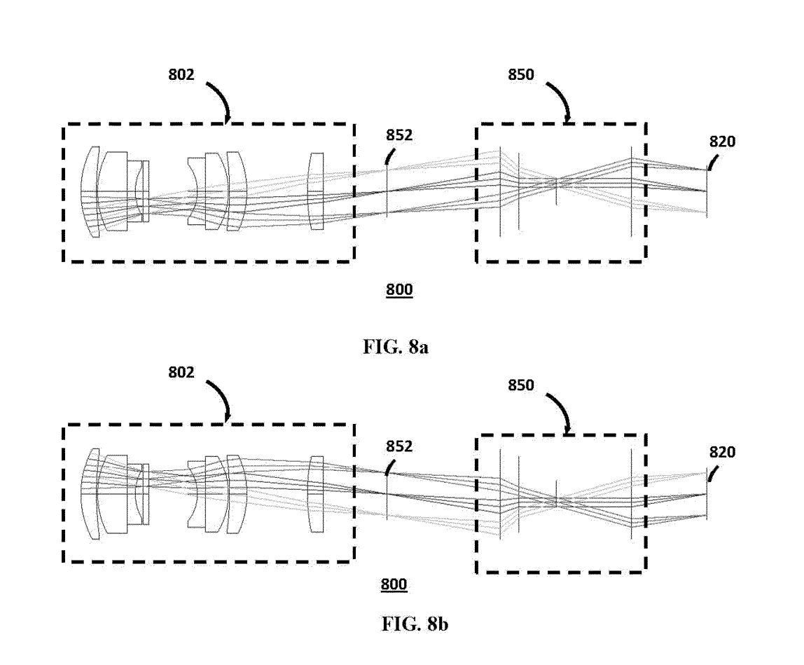

FIG. 8a depicts a similar capture device 800 comprising a similar objective lens 802 incorporating the objective aperture 306 and the at least two apertures 310 and 312 of FIG. 3, a relay lens 850 and a sensor 820 when one of the sequential apertures (e.g., one of the at least two apertures 310 and 312) is fully transmitting while the other aperture is fully closed. An intermediate image 852 is again formed, and relayed to the plane of the sensor 820, providing a captured image from the perspective of a displaced entrance pupil.

FIG. 8b depicts the other sequential aperture (e.g., the other one of the at least two apertures 310 and 312) opened and the first one closed, providing a captured image from the perspective of an oppositely displaced entrance pupil. The two images together form a stereoscopic pair. At high speed capture rates, several images may be captured in this way and post-processed to reduce motion and depth artifacts.

In an embodiment, the relay lens 650 illustrated in FIG. 6 is a bilateral telecentric lens, implying the lens 650 is telecentric both on the intermediate image side and at the sensor 620. The relay lens 650 may also be object-side telecentric.

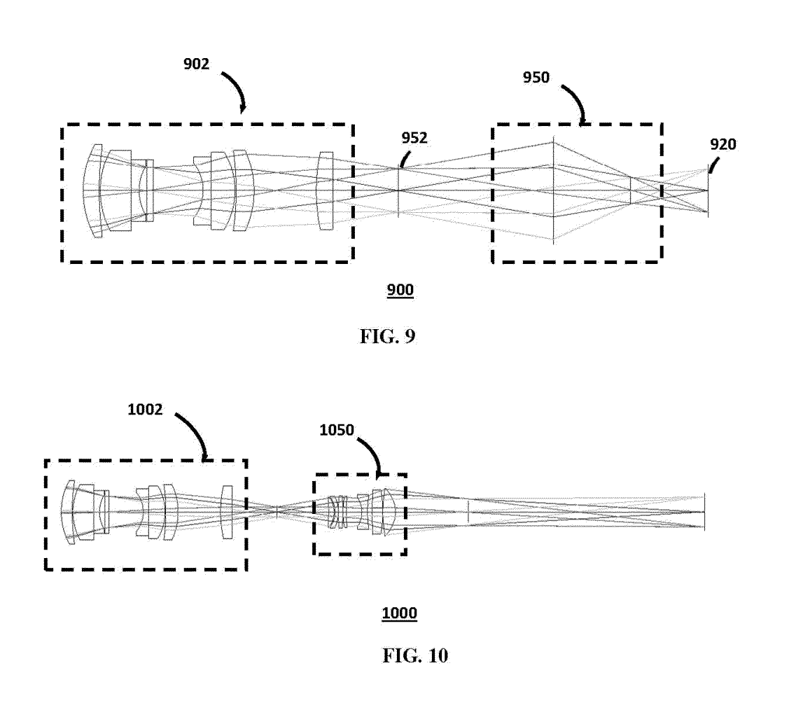

FIG. 9 depicts a capture device 900 that is similar to the capture device 600 with an object-side telecentric zoom relay lens. The capture device 900 includes an objective lens 902 and an object-side telecentric zoom relay lens 950, where the relay lens 950 is telecentric at the intermediate image 952 and non-telecentric at the plane of the sensor plane 920.

FIG. 10 depicts a capture device 1000 that is similar to the capture device 600 with a thick lens design for an object-side telecentric relay lens. The capture device 1000 includes an objective lens 1002 and an object-side telecentric zoom relay lens 1050 in such a configuration.

It should be noted that embodiments of the present disclosure may be used in a variety of optical capture systems. Aspects of the present disclosure may be used with practically any apparatus related to optical image capture and electrical devices, optical systems, capture systems or any apparatus that may contain any type of optical system. Accordingly, embodiments of the present disclosure may be employed in optical systems, devices used in visual and/or optical presentations, capture peripherals and so on and in a number of environments including consumer devices, still and video cameras, camera phones, smart phones, webcams, commercial-grade cameras, security cameras, vehicle-based cameras, and so on.

Additionally, it should be understood that the embodiment is not limited in its application or creation to the details of the particular arrangements shown, because the embodiment is capable of other variations. Moreover, aspects of the embodiments may be set forth in different combinations and arrangements to define embodiments unique in their own right. Also, the terminology used herein is for the purpose of description and not of limitation.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A capture apparatus comprising:
an objective lens operable to receive light along an input light path;
a fixed objective lens aperture defined in the input light path and having an objective lens optical axis;
at least two offsetting apertures operable to receive light transmitted through the fixed objective lens aperture, the at least two offsetting apertures having transmitting areas offset from the objective lens optical axis by a displacement distance; and
a sensor operable to receive light transmitted by the at least two offsetting apertures.

2. The stereoscopic capture apparatus according to claim 1, wherein the at least two offsetting apertures comprise mechanical irises.

3. The stereoscopic capture apparatus according to claim 1, wherein the at least two offsetting apertures comprise one or more liquid crystal shutters.

4. The stereoscopic capture apparatus according to claim 1, wherein the at least two offsetting apertures have non-circular shapes.

5. The stereoscopic capture apparatus according to claim 1, further comprising a relay lens between the objective lens and the sensor.

6. The stereoscopic capture apparatus according to claim 1, further comprising a zoom relay lens between the objective lens and the sensor, the zoom relay lens operable to maintain a substantially constant objective entrance pupil size and constant image resolution at the sensor over a varying system field of view.

7. The stereoscopic capture apparatus according to claim 1, wherein the displacement distance is zero.

8. The stereoscopic capture apparatus according to claim 1, wherein the displacement distance is greater than zero and equal to or less than a radius of the fixed objective lens aperture.

9. A method of capturing imagery, comprising:
providing a capture device comprising:
an objective lens operable to receive light along an input light path;
a fixed objective lens aperture defined in the input light path and having an objective lens optical axis;
at least two offsetting apertures operable to receive light transmitted through the fixed objective lens aperture, the at least two offsetting apertures having transmitting areas offset from the objective lense optical axis by a displacement distance; and
a sensor operable to receive light transmitted by the at least two offsetting apertures;
transmitting a first stereoscopic view through a first of the at least two offsetting apertures during a first portion of a first frame; and
transmitting a second stereoscopic view through a second of the at least two offsetting apertures during a second portion of the first frame;
wherein the first and second portion of the first frame substantially do not overlap and each have a centroid of image energy near the middle of the first frame in time.

10. The method of claim 9, wherein the first portion of the first frame comprises substantially first and fourth quarters of the first frame, and the second portion of the first frame comprises substantially second and third quarters of the first frame.

11. The method of claim 10, further comprising:
transmitting the first stereoscopic view through the first of the at least two offsetting apertures during a first portion of a second frame; and
transmitting the second stereoscopic view through the second of the at least two offsetting apertures during a second portion of the second frame;
wherein the first and second portion of the second frame substantially do not overlap and each have a centroid of image energy near the middle of the second frame in time.

12. The method of claim 11, wherein the first portion of the second frame comprises substantially second and third quarters of the second frame, and the second portion of the second frame comprises substantially first and fourth quarters of the second frame.

13. The method of claim 11, wherein the first portion of the second frame comprises substantially first and fourth quarters of the second frame, and the second portion of the second frame comprises substantially second and third quarters of the second frame.

14. The method of claim 9, wherein the first portion of the first frame comprises substantially second and third quarters of the frame, and the second portion of the first frame comprises substantially first and fourth quarters of the frame.

15. The method of claim 9, wherein the capture device further comprises a relay lens disposed between the objective lens and the sensor.

16. A stereoscopic capture apparatus comprising:
an objective lens operable to receive light along an input light path;
a fixed objective lens aperture defined in the input light path and having an objective lens optical axis;
at least two offsetting apertures operable to receive light transmitted through the fixed objective lens aperture, the at least two offsetting apertures having transmitting areas offset from the objective lense optical axis by a displacement distance;
a sensor operable to receive light transmitted by the at least two offsetting apertures;
a relay lens between the at least two offsetting apertures and the sensor.

17. The stereoscopic capture apparatus according to claim 5, wherein the relay lens is a bilateral telecentric lens.

18. The stereoscopic capture apparatus according to claim 5, wherein the relay lens is a zoom bilateral telecentric lens.

19. The stereoscopic capture apparatus according to claim 5, wherein the relay lens is an object-side telecentric lens.

20. The stereoscopic capture apparatus according to claim 5, wherein the relay lens is a zoom object-side telecentric lens.
